(19) United States
(12) Patent Application Publication
(10) Pub. No.: US 2002/0169691 A1
(43) Pub. Date: Nov. 14, 2002

(54) Mail order sale method

(76) Inventors: Yasuhiro Yukimachi, Osaka (JP); Kazuya Yamanaka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/140,334

(22) Filed: May 8, 2002

(30) Foreign Application Priority Data
May 11, 2001 (JP) 2001-141793

(51) Int. Cl. G06F 17/60

(52) U.S. Cl. 705/26

(57) ABSTRACT

The aim is to improve convenience of Japanese catalogues for foreigners. Japanese catalogues are prepared and distributed to foreign purchasers in and out of Japan. On the other hand, a virtual catalogue in which the Japanese catalogues are translated to a language used by the foreigners, such as English, Chinese or Korean is put into a database and registered through an Internet server. Each foreign purchaser accesses the registered server site in the database, opens the virtual catalogue in a desired language, and selects an item of goods by associating the virtual catalogue with the catalogue e.g. by referring to item numbers. In this way, the purchaser can buy goods with better understanding. This improves convenience. On the other hand, for the mail-order sale firm, it is possible to improve the service and also to suppress the sales cost compared with when catalogues in many languages are prepared and distributed.

### BACKGROUND OF THE INVENTION

This invention relates to a mail order sale method in which goods or articles are purchased by seeing a catalogue.

Nowadays when lifestyle has been diversified, the type of shopping is changing from shop fronts to mail orders. Such mail order sale is roughly classified into one through catalogues, one through television (so-called TV shopping) and one through Internet (so-called Electronic Commerce). Among them, in particular, sale through Internet is spreading rapidly and the transaction amounts are increasing because with spreading of personal computers, it is available at lower cost.

Since the mail order sale through Internet is intended not only for one country but all over the world, a system has been proposed in which goods catalogues are offered not only in one language but languages desired by purchasers (JP patent publication 10-312398).

On the other hand, for catalogue sale too, seeing Japanese catalogues, foreign purchasers other than Japanese, e.g. Taiwanese, are desirous of purchasing listed goods. In view of convenience of purchasers, it is preferable for mail order sale firms to prepare catalogues in languages used by the purchasers, such as Chinese, and distribute the Chinese catalogues to the purchasers.

But it is extremely costly to translate descriptions of all the goods listed in a catalogue and all pages and print them. Thus, heretofore, only several pages including the front page are translated and distributed.

Generally, in buying articles or goods, it is ordinary to make a selection by comparison with other goods of the same kind. At this time, one wants to compare it with other goods by collation. But in the mail order sale through Internet using various languages, virtual catalogues in a plurality of languages are made into a database and registered in an Internet delivery server, so that purchasers can open the virtual catalogues by accessing the server. With virtual catalogues, one can see only the contents displayed on a display screen at once. When one sees a different page (screen), the previous screen disappears. Thus, it is difficult to compare a plurality of goods at once and it takes time for re-display and it is troublesome.

In contrast, with catalogues, by turning pages, goods can be easily compared. Thus it is more convenient. Also, since catalogues are generally printed matter, goods photos are beautiful and the desire to buy heightens.

But if most part of such a catalogue is in an ununderstandable language, the desire to buy will dwindle. Heretofore, it was the actual circumstances that in buying goods by a catalogue, foreign purchasers do not sufficiently understand descriptions of goods but buy by judging only by photos. This can cause trouble after purchasing.

An object of this invention is to make it possible to deepen understanding of the contents of a catalogue even if the language used in the catalogue is not a desired one.

### SUMMARY OF THE INVENTION

In order to solve the object, according to this invention, catalogues are prepared in one language such as Japanese. Catalogues in one language have to be prepared anyway. So it costs the same expenses as before to prepare and distribute them. And the virtual catalogue corresponding to the catalogues is prepared in a language different from the language used for the catalogues, such as English, Chinese or Korean, which is different from Japanese, and made into a database.

Looking in a catalogue, a purchaser can access the database by any communications means such as the Internet and open the virtual catalogue in a desired language, so that he can see a catalogue in an understandable language. Thus, it is possible to select an item of goods by associating the virtual catalogue with the catalogue, so that he can purchase the goods with sufficient understanding. This improves convenience. On the other hand, for the mail order sale firm, the service improves.

According to the present invention, there is provided a mail-order sale method in which a purchaser selects an item of goods from a catalogue and notify a mail-order sale firm of its item number by communication to buy the item, characterized in that a virtual catalogue in which description in one language in the catalogue is translated into other language is put into a database, whereby when a purchaser looks in the catalogue, he can access the database through a communications network, open the virtual catalogue, select a desired language to read the virtual catalogue, display a portion of the virtual catalogue corresponding to the catalogue, and select an item of goods.

For the catalogues, a Japanese version is preferable for use in our country. Also, irrespective of whether they are in Japanese or not, it is possible to employ not only catalogues in which the entire part is prepared in one language but ones in which desired portions (pages) such as the front page and purchasing method are translated into a language used by the purchaser. For the communications network, various means such as wireless and wired telephone networks can be selected. But it is preferable to employ the rapidly spreading Internet. Via the Internet, it is possible to access the database inexpensively from all over the world.

The virtual catalogue may comprise description in the catalogue, wherein collation of corresponding portions on the catalogue and the virtual catalogue is made by referring to item numbers, and wherein by inputting an item number in the virtual catalogue, translation of the description of the corresponding item of goods on the virtual catalogue is displayed. By doing so, ones requiring a large data capacity such as photographs are eliminated from the virtual catalog. This facilitates indication of translation.

Other features and objects of the present invention will become apparent from the following description made with reference to the accompanying drawings, in which:

### BRIEF DESCRIPTION OF THE DRAWINGS

FIG. 1 is a schematic view showing one embodiment;

FIG. 2 is a perspective view of a catalogue; and

FIG. 3 is a partial enlarged view of the same.

### DETAILED DESCRIPTION OF THE PREFERRED EMBODIMENT

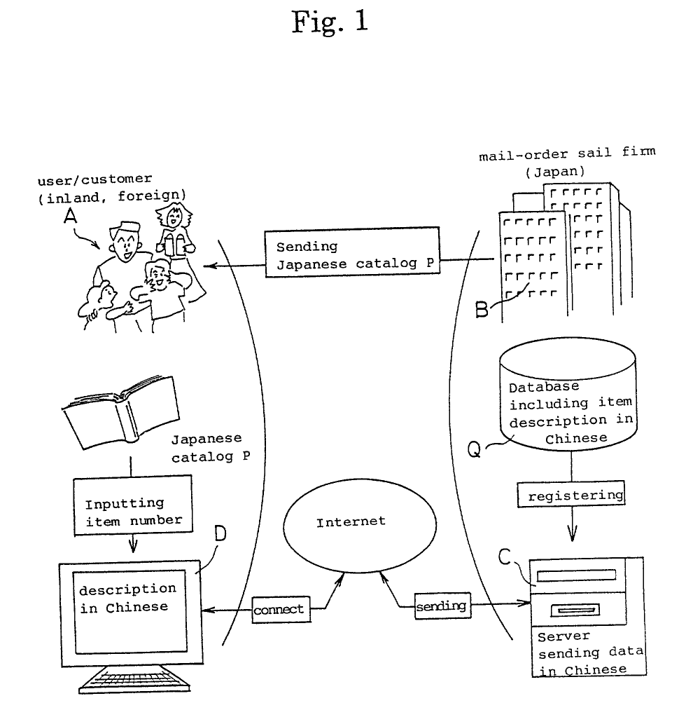

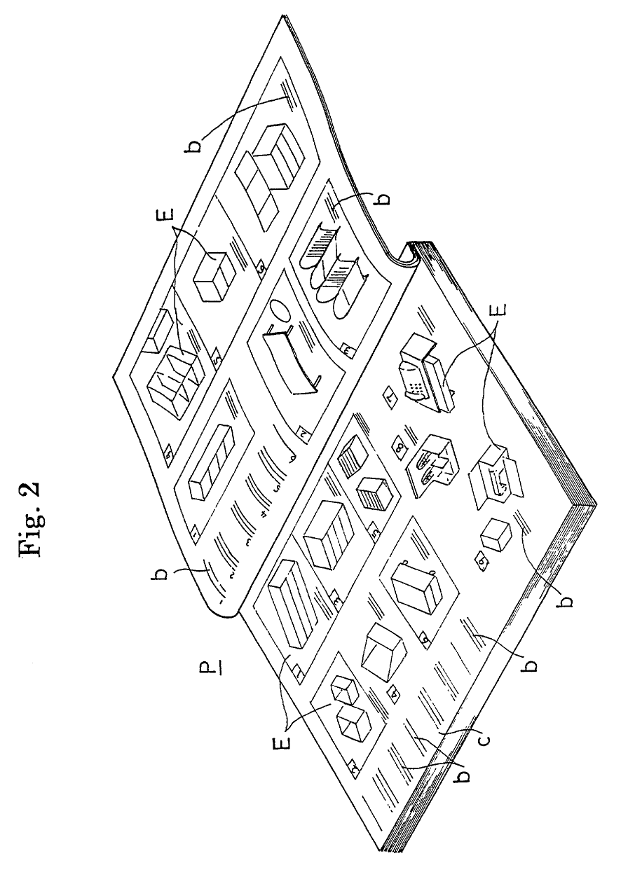

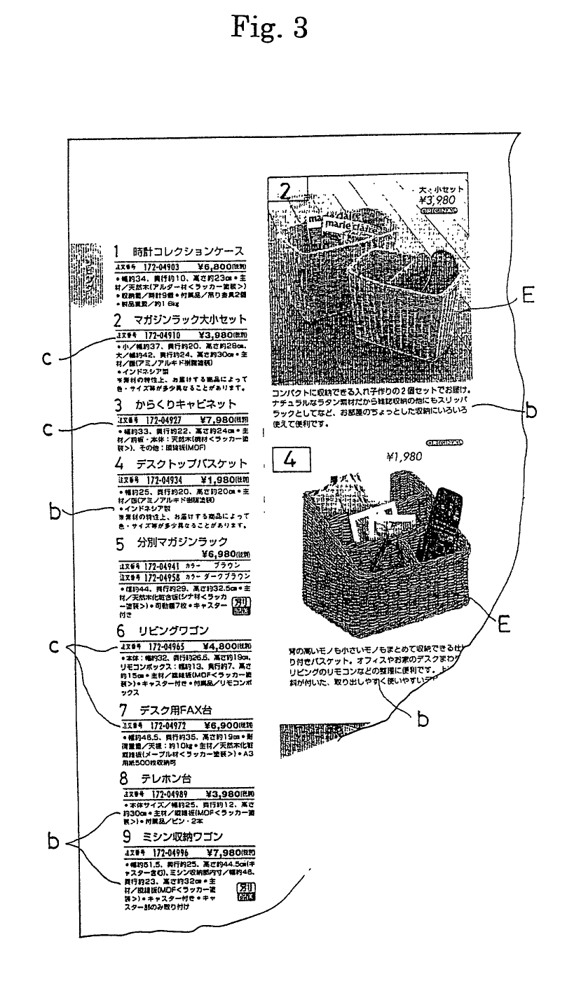

An embodiment of this invention is shown in FIGS. 1-3. As shown, it is assumed that mail order sale is made to users/customers A (purchasers) using Chinese in and without Japan by use of catalogues in Japanese. First, a mail-order sale firm B prepares catalogues P (FIG. 2) in which photos E of goods are listed with description b in Japanese and distributes them to the purchasers A using e.g. Chinese as shown in FIG. 1. The description b of the goods includes the size, material, features and use of the goods.

Item numbers (order numbers) c are assigned to the respective goods on the catalogue. The mail-order sale firm B prepares a database (virtual catalogue) Q in which description b corresponding to each item number c is translated into Chinese, and registers it at an Internet server C. The server may be owned by the mail-order sale firm B themselves or owned by a different entity. When one opens the home page of the mail-order sale firm B, he can be linked to the virtual catalogue.

If a purchaser A who has received a catalogue P finds any item he wants to buy, he connects his personal computer D to the Internet and opens the site of the virtual catalogue of the catalogue P. When he enters an item number C in the search site, the description b of the particular item is displayed in Chinese. As before, for item number C, Arabic figures and Roman characters are used. By carrying out this operation for each item of goods, one can select goods by reading description b in a language he can understand.

In this embodiment, by entering item number c, only the description of goods is displayed. But besides the description of goods, photos E of goods for the item number c may be simultaneously displayed. Also, while only the description of goods was the virtual catalogue in this embodiment, a virtual catalogue of the same contents as the catalogue P, including photos E of goods, may be prepared and registered at the server C so that when a purchaser enters an item number or page number in the search site, the same item or page on the virtual catalogue as those on the catalogue can be opened.

In the embodiment, the virtual catalogue was in Chinese for example. But this invention can also be employed for a virtual catalogue in any other language such as English or Korean. In this case, it is adapted so that when the home page is opened, one can link to the virtual catalogue in such a language. Similarly, the catalogues are not limited to a Japanese version.

Goods referred to in this invention include not only ordinary goods but services such as travels, real estate, finance, insurance, recruiting, marriage, automobile sales and events.

According to this invention, as described above, since it is possible to select goods by associating the catalogues with a virtual catalogue in any language, it is possible to improve the convenience of purchasers and the service of the mail-order sale firm.

What is claimed is:

1. A mail-order sale method in which a purchaser selects an item of goods from a catalogue and notify a mail-order sale firm of its item number by communication to buy the item, characterized in that:
a virtual catalogue in which description in one language in said catalogue is translated into other language is put into a database, whereby when a purchaser looks in said catalogue, he can access said database through a communications network, open said virtual catalogue, select a desired language to read said virtual catalogue, display a portion of said virtual catalogue corresponding to said catalogue, and select an item of goods.

2. A mail-order sale method as claimed in claim 1 wherein said virtual catalogue comprises description in said catalogue, wherein collation of corresponding portions on said catalogue and said virtual catalogue is made by referring to item numbers, and wherein by inputting an item number in said virtual catalogue, translation of the description of the corresponding item of goods on said virtual catalogue is displayed.

3. A mail-order sale method as claimed in claim 1 or 2 wherein said communication network is the internet and said database is registered at an internet server, wherereby a purchaser can access said server to open said virtual catalogue.

4. A mail-order sale method as claimed in any of claims 1-3 wherein said catalogue is written in Japanese.
